(19) United States
(12) Patent Application Publication
(10) Pub. No.: US 2019/0012271 A1
(43) Pub. Date: Jan. 10, 2019

(54) MECHANISMS TO ENFORCE SECURITY WITH PARTIAL ACCESS CONTROL HARDWARE OFFLINE

(71) Applicant: QUALCOMM Incorporated, San Diego, CA (US)

(72) Inventors: Christophe AVOINNE, Campbell, CA (US); Samar ASBE, San Diego, CA (US); Thomas ZENG, San Diego, CA (US); Jean-Louis TARDIEUX, San Diego, CA (US); Jeffrey SHABEL, San Diego, CA (US); Azzedine TOUZNI, Carlsbad, CA (US)

(21) Appl. No.: 15/641,765

(22) Filed: Jul. 5, 2017

(51) Int. Cl. G06F 12/14; G06F 12/1027; G06F 12/1009; G06F 1/32

(52) U.S. Cl. CPC G06F 12/145; G06F 12/1483; G06F 12/1027; G06F 2212/681; G06F 1/3287; G06F 2212/1052; G06F 2212/657; G06F 12/1009

(57) ABSTRACT

One feature pertains to an apparatus that includes a memory circuit, a system memory-management unit (SMMU), and a processing circuit. The memory circuit stores an executable program associated with a client. The SMMU enforces memory access control policies for the memory circuit, and includes a plurality of micro-translation lookaside buffers (micro-TLBs), macro-TLB, and a page walker circuit. The plurality of micro-TLBs include a first micro-TLB that enforces memory access control policies for the client. The processing circuit loads memory address translations associated with the executable program into the first micro-TLB, and initiates isolation mode for the first micro-TLB causing communications between the first micro-TLB and the macro-TLB and between the first micro-TLB and the page walker circuit to be severed. The first micro-TLB continues to enforce memory access control policies for the client while in isolation mode.

### BACKGROUND

### Field

Various aspects of the present disclosure relate to system memory management units and, more particularly, to methods, apparatuses, and systems for enforcing memory access control policies while major components of the system memory management unit is offline.

### Background

A system memory management unit (SMMU) is a computer hardware unit that, among other things, provides memory virtualization and also memory access permission control. Thus, an SMMU performs translation of virtual memory addresses to physical addresses and enforces memory access control policies for various clients attempting to access memory of the system.

A distributed SMMU includes many different components. For example, an SMMU may include a large translation lookaside buffer (TLB) that is shared among various clients of the system. Such a shared TLB may be known as a “macro-TLB.” Generally, a TLB is a memory cache that is used to reduce the time taken to access a user memory location by storing recent translations of virtual memory to physical memory. A client or process may first access the TLB to obtain the virtual memory to physical memory address translation in order to save time. If the translation is not found at the TLB (i.e., a TLB miss), then a page walker circuit of the SMMU must perform a page walk of the memory page tables to determine the translation.

Current distributed SMMUs may include a plurality of smaller, localized TLBs (known as “micro-TLBs”) in addition to the macro-TLB. The micro-TLBs may be distributed across the system and may be limited in providing memory access control to specific clients. In such systems, the micro-TLBs must remain in communication with other components of the SMMU, including the macro-TLB and the page walker circuit, in order to correctly operate and enforce memory access control policies to the clients and memory circuits they serve. Thus, if the macro-TLB and/or page walker circuit of the SMMU goes offline (e.g., low power state, sleep mode, turned OFF, etc.), then the localized micro-TLBs will not receive any translation lookaside buffer maintenance operations from the macro-TLB and page walker circuit, which may hamper or inhibit the micro-TLBs from enforcing memory access control policies for the clients they serve. Consequently, power hungry components like the macro-TLB and the page walker circuit, which may consume 5 to 10 times the power of a micro-TLB, must remain powered ON and operational in order for a micro-TLB to perform its functions.

There is a need for SMMUs that have micro-TLBs which may remain fully functional and enforce memory access control policies even if other components of the SMMU, such as the macro-TLB and page walker circuits, are inaccessible (e.g., offline). Methods, apparatuses, and systems are described herein that provide SMMUs having such micro-TLBs that remain fully functional while the rest of the system and SMMU may go offline.

### SUMMARY

One feature provides an apparatus comprising a memory circuit storing an executable program associated with a client, a system memory-management unit (SMMU) adapted to enforce memory access control policies for the memory circuit, the SMMU including a plurality of micro-translation lookaside buffers (micro-TLBs), a macro-translation lookaside buffer (macro-TLB), and a page walker circuit, the plurality of micro-TLBs including a first micro-TLB that enforces memory access control policies for the client, and a processing circuit communicatively coupled to the memory circuit and the SMMU, the processing circuit adapted to load memory address translations associated with the executable program into the first micro-TLB, and initiate isolation mode for the first micro-TLB to cause communications between the first micro-TLB and the macro-TLB and between the first micro-TLB and the page walker circuit to be severed, the first micro-TLB to continue to enforce memory access control policies for the client while in isolation mode.

According to one aspect, the macro-TLB and the page walker circuit enter a lower power state while the first micro-TLB is in isolation mode. According to another aspect, the memory address translations loaded into the first micro-TLB provide a mapping between virtual memory addresses and physical memory addresses of the memory circuit. According to yet another aspect, the first micro-TLB includes a register that stores a client identifier that identifies the client and defines a memory aperture of the first memory circuit that the client is authorized to access.

According to one aspect, the first micro-TLB determines that each memory address translation associated with the executable program being loaded into the first micro-TLB includes an identifier that matches the client identifier stored at the register of the first micro-TLB before allowing the memory address translation to be loaded and locked into the first micro-TLB. According to another aspect, the executable program is stored at the memory aperture of the first memory circuit. According to yet another aspect, the apparatus further comprises a hypervisor adapted to associate the client identifier to the client and write the client identifier to the register.

According to one aspect, the first micro-TLB invalidates non-locked memory address translations stored at the first micro-TLB prior to entering isolation mode. According to another aspect, the processing circuit is further adapted to cease isolation mode for the first micro-TLB causing the first micro-TLB to exit isolation mode and reestablish communications with the macro-TLB and the page walker circuit. According to yet another aspect, the first micro-TLB invalidates all memory address translations stored at the first micro-TLB upon exiting isolation mode and reestablishing communications with the macro-TLB and the page walker circuit.

According to one aspect, the processing circuit ceases isolation mode after the first micro-TLB reports a fault caused by the client attempting to access a memory region of the memory circuit that the client is unauthorized to access. According to another aspect, the processing circuit is further adapted to initiate a lower power mode for the micro-TLB, and wherein the macro-TLB and the page walker circuit remain in a lower power state while the micro-TLB is in the lower power mode. According to yet another aspect, the apparatus further comprises a hypervisor adapted to authenticate the executable program stored at the first memory circuit during a boot process and configure page tables that map to a memory aperture of the first memory circuit where the executable program is stored.

According to one aspect, the first micro-TLB continuing to enforce memory access control policies for the client while in isolation mode includes receiving at the first micro-TLB a memory access request from the client that includes a client identifier identifying the client, the request indicating a memory region of the memory circuit the client desires access to, determining at the first micro-TLB that the client identifier provided by the client in the memory access request matches a stored client identifier value at the micro-TLB associated with the memory region of the memory circuit the client desires access to, and providing the client a memory address translation associated with the memory region of the memory circuit the client desires access to. According to yet another aspect, the apparatus further comprises a local master circuit adapted to reprogram the first micro-TLB while in isolation mode.

Another feature provides a method comprising enforcing memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client, enforcing memory access control policies for the client with a first micro-TLB of the plurality of micro-TLBs, loading memory address translations for the executable program into the first micro-TLB, and initiating isolation mode for the first micro-TLB causing communications between the first micro-TLB and the macro-TLB and between the first micro-TLB and the page walker circuit to be severed, the first micro-TLB continuing to enforce memory access control policies for the client while in isolation mode. According to one aspect, the method further comprises ceasing isolation mode for the first micro-TLB causing the first micro-TLB to exit isolation mode and reestablish communications with the macro-TLB and the page walker circuit.

Another feature provides an apparatus comprising means for enforcing memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client, means for enforcing memory access control policies for the client with a first micro-TLB of the plurality of micro-TLBs, means for loading memory address translations for the executable program into the first micro-TLB, and means for initiating isolation mode for the first micro-TLB causing communications between the first micro-TLB and the macro-TLB and between the first micro-TLB and the page walker circuit to be severed, the first micro-TLB continuing to enforce memory access control policies for the client while in isolation mode. According to one aspect, the apparatus further comprises means for ceasing isolation mode for the first micro-TLB causing the first micro-TLB to exit isolation mode and reestablish communications with the macro-TLB and the page walker circuit, the first micro-TLB invalidating all memory address translations stored at the first micro-TLB upon exiting isolation mode.

Another feature provides a non-transitory computer-readable storage medium having instructions stored thereon, which when executed by at least one processor causes the processor to enforce memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client at the memory circuit, enforce memory access control policies for the client with a first micro-TLB of the plurality of micro-TLBs, load memory address translations for the executable program into the first micro-TLB, and initiate isolation mode for the first micro-TLB to cause communications between the first micro-TLB and the macro-TLB and between the first micro-TLB and the page walker circuit to be severed, the first micro-TLB to continue to enforce memory access control policies for the client while in isolation mode.

### BRIEF DESCRIPTION OF THE DRAWINGS

FIG. 1 illustrates a high level block diagram of an electronic device.

FIG. 2 illustrates a conceptual block diagram of a micro-TLB and a memory circuit.

FIG. 3 illustrates a conceptual block diagram of a hypervisor of the device performing steps associated with authentication and loading of an executable program image associated with a client.

FIG. 4 illustrates a high-level process flow diagram of the device enforcing memory access control policies while a portion of the SMMU enters a lower power state.

FIG. 5 illustrates a conceptual block diagram of a device client in a load phase.

FIG. 6 illustrates a conceptual block diagram of the device client in a load phase where a fault is being reported.

FIG. 7 illustrates a conceptual block diagram of a device client in isolation mode.

FIG. 8 illustrates a conceptual block diagram of a device client exiting isolation mode.

FIG. 9 illustrates a state diagram of the system memory management unit enforcing access control policies while some components of the SMMU go offline.

FIGS. 10A, 10B, and 10C illustrate a process flow diagram for enforcing access control policies of a client while some components of the SMMU go offline.

FIG. 11 illustrates a schematic block diagram of a device.

FIG. 12 illustrates a method for enforcing access control policies while some components of the SMMU go offline.

FIG. 13 is a high level block diagram of a second exemplary electronic device.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, an aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

In the following description and claims, the term “coupled” may mean that two or more elements are in direct physical or electrical contact. However, “coupled” may also mean that two or more elements are not in direct contact with each other, but yet still co-operate or interact with each other. In the following description and claims, the term “lower power state” means a state where the device or circuit operating in such a state is consuming less power than it ordinarily would while fully powered and ON. Thus, a lower power state includes states commonly known as “sleep mode” and “low power mode,” and also a “power OFF” state.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

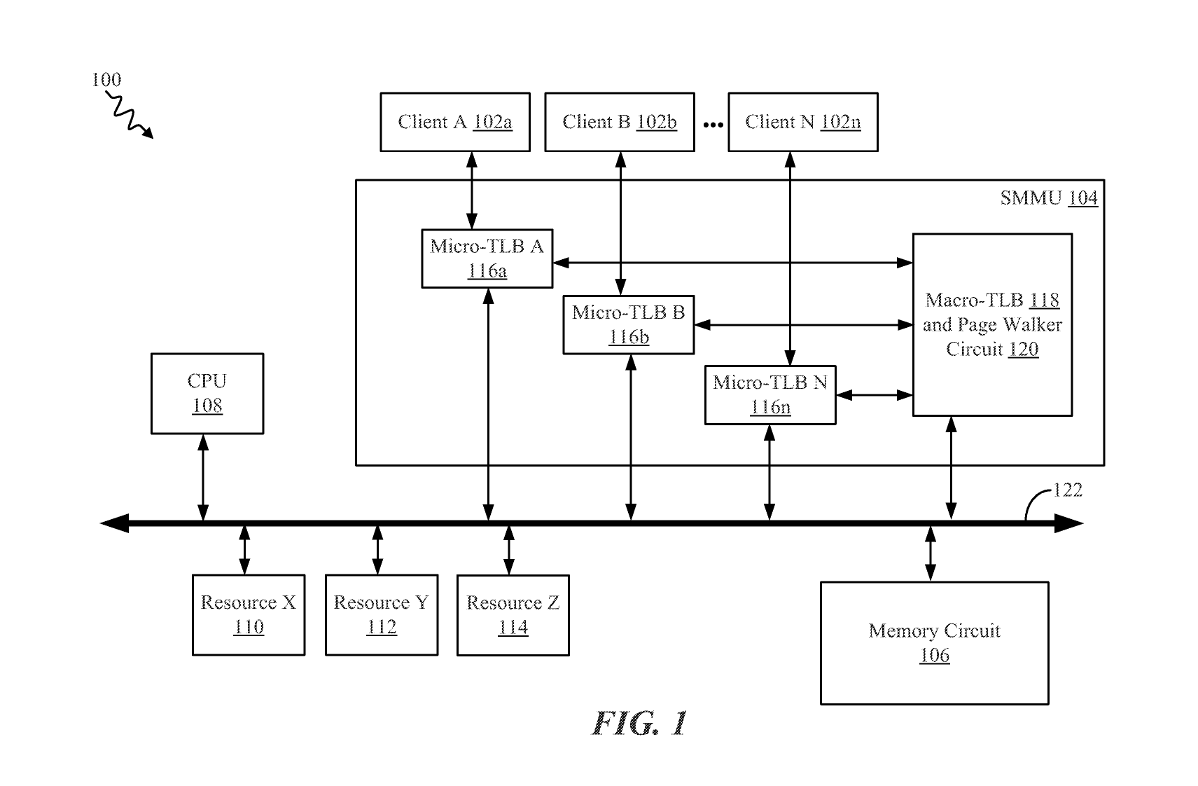

FIG. 1 illustrates a high level block diagram of an electronic device 100 according to one aspect. The device 100 may be generally any electronic device that includes memory and utilizes a memory management unit to control access to its memory. For example, the device 100 may be, but is not limited to, a wireless communication device, such as a mobile phone, smartphone, laptop, desktop computer, tablet, wearable device, etc. The device 100 may include one or more clients 102a, 102b, . . . 102n, a system memory management unit (SMMU) 104, at least one memory circuit/module 106, a central processing unit (CPU) 108, and a plurality of resources 110, 112, 114. The SMMU 104 may include a plurality of micro-TLBs 116a, 116b, . . . 116n, a macro-TLB 118, and a page walker circuit/module 120. The clients 102a-102n, SMMU 104, memory circuit 106, CPU 108, and resources 110, 112, 114 may be communicatively coupled via a communication bus 122 (e.g., interconnect). The SMMU is one example of a means for enforcing memory access control policies for a memory circuit.

According to one aspect, the device 100, including its clients 102a-102n, SMMU 104, memory circuit 106, CPU 108, resources 110-114, and/or bus 122, may be based on a reduced instruction set computing (RISC) architecture. In some RISC architectures, a micro-TLB may be known as “translation buffer unit” and a macro-TLB in combination with a page walker may be known as a “translation control unit.” According to another aspect, the device 100, including its clients 102a-102n, SMMU 104, memory circuit 106, CPU 108, resources 110-114, and/or bus 122, may be a system-on-chip (SoC) or system-on-module (SoM).

A client 102a-102n may generally be any subsystem of the device 100 that needs some amount of memory 106. Some non-limiting, non-exclusive examples of a client include a digital signal processor (DSP), a co-processor, a hardware accelerator, direct memory access (DMA) controllers, audio system controllers, sensor controllers, touchscreen controllers, graphics processing unit, network processing unit, numerical processing unit, and input/output interfaces (e.g., peripheral component interconnect (PCI), PCI-E, universal serial bus (USB), etc.).

A resource 110, 112, 114 may be a hardware resource component of the device 100 that a client 102a-102n needs or desires access to. Examples of resources include various sensors, speakers, displays, input/output devices (e.g., PCI, PCI-E, USB, etc.), memory circuits, caches, configuration spaces, etc. For example, client A 102a may be a DSP that periodically requires device temperature information obtained by resource X 110, which may be a thermometer. In order to carry out its processes, the DSP (e.g., client A 102a) may also need to execute a program image stored at the memory circuit 106.

Each micro-TLB 116a-116n may be associated with and serve one or more clients 102a-102n by allowing access and enforcing memory access control policies for its clients 102a-102n. For example, micro-TLB A 116a may be associated with and serve client A 102a, micro-TLB B 116b may be associated with and serve client B 102b, and so on. Thus, micro-TLB A 116a, for example, may enforce access control policies of a portion of the memory circuit 106 (e.g., a specific aperture of the memory circuit 106) for client A 102a. Micro-TLB B 116b, for example, may enforce access control policies of a portion of the memory circuit 106 (e.g., a specific aperture of the memory circuit 106) for client B 102b, and so on.

The macro-TLB 118 and page walker circuit 120 is shared among all the clients 102a-102n via the plurality of micro-TLBs 116a-116n. For example, a TLB miss at a local micro-TLB 116a may cause a page walk to be performed by the page walker circuit 120 in order to obtain the memory address translation needed by a given client (e.g., client A 102a). Generally, the macro-TLB 118 and page walker circuit 120 are online (e.g., fully powered ON), operational, and in communication with the plurality of micro-TLBs 116a-116n.

According to one aspect, one or more clients 102a-102n may execute programs stored at the memory circuit 106 and may access one or more resources 110, 112, 114 while the rest of the SMMU 104, such as the macro-TLB 118 and page walker circuit 120, enters a lower power state. For example, client A 102a may access the memory circuit 106 and resource X 110 while much of the SMMU 104 (e.g., macro-TLB 118 and page walker circuit 120) is in a lower power state. Thus, micro-TLB A 116a may remain online and enforce access control policies and provide memory address translations for client A 102a despite the micro-TLB A 116a having severed communication with the rest of the SMMU 104 (e.g., macro-TLB 118 and page walker circuit 120) and being unable to receive maintenance operations and updates from the macro-TLB 118 and/or page walker circuit 120. Micro-TLBs 116a-116n that remain operational by enforcing memory access control policies for their respective clients while the macro-TLB 118 and/or page walker circuit 120 are in a lower power state (e.g., communications severed) are herein referred to as being in an “isolation state.” This allows the rest of the system, including the macro-TLB 118 and page walker circuit 120, the ability to enter a lower power state while memory access control policies are still enforced for the clients that remain active.

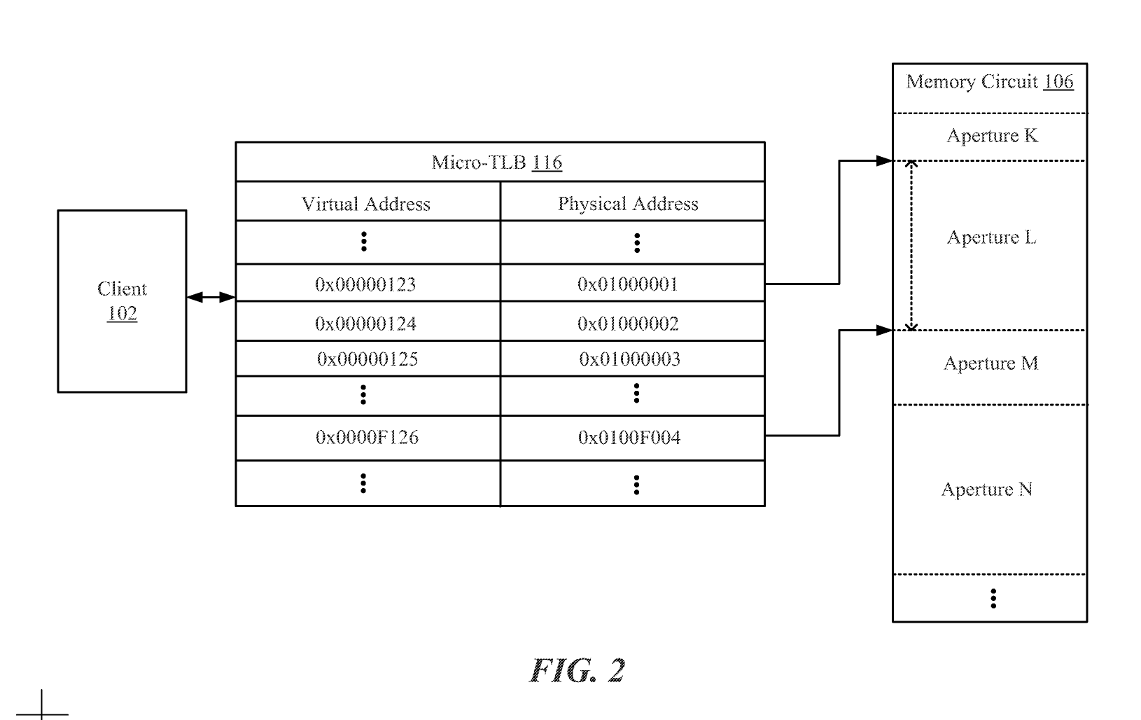

FIG. 2 illustrates a conceptual block diagram of a micro-TLB 116 and the memory circuit 106 according to one aspect. The micro-TLB 116 includes page table entries of memory address translations between virtual memory addresses and physical memory addresses for select memory locations. Specifically, each virtual memory address maps to a specific physical address of the memory circuit 106. In the example shown, a range of virtual memory addresses 0x00000123 through 0x000F126 may be associated with a client 102. These memory addresses map to physical memory addresses 0x01000001 through 0x0100F004 which corresponds to memory aperture L at the memory circuit 106. As will be described in greater detail below, the client 102 may only have access to a specific memory aperture and the micro-TLB 116 serving the client enforces memory access control policies ensuring that the client does not access memory locations outside its designated aperture(s).

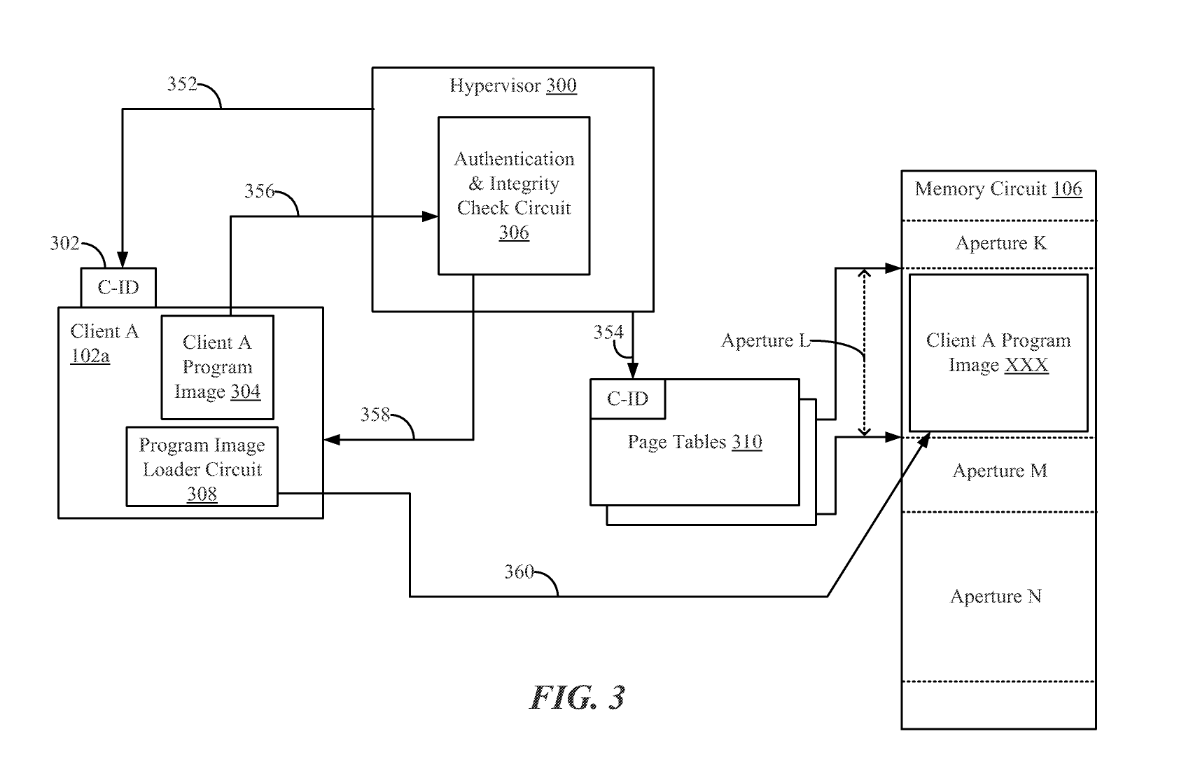

FIG. 3 illustrates a conceptual block diagram of a hypervisor 300 of the device 100 performing steps associated with authentication and loading of an executable program image associated with a client according to one aspect. The process illustrated in FIG. 3 and described below may be performed during a boot sequence of the device 100. The device 100 (see FIG. 1) may further include a management entity (e.g., hypervisor 300) that creates and runs virtual machines on the device 100. The hypervisor 300 may generate and assign 352 a client identifier 302 (e.g., stream identifier (SID), virtual machine identifier (VMID), etc.) that is uniquely associated and identifies the client (e.g., client A 102a). Client A 102a may also have an executable program image 304 that needs to be authenticated and vetted by the hypervisor 300 during boot so that the client A 102a may load and later execute it. As such, the hypervisor 300 may obtain 356 the client program image 304 and utilize an authentication and integrity check circuit 306 to authenticate and integrity check the client program image 304. The hypervisor 300 may then notify 358 the client 102a that authentication and integrity check was successful thereby allowing the client 102a via a program image loader circuit 308 to load 360 the program image 304 into a memory aperture (e.g., aperture L) assigned by hypervisor 300 to store the program image for that specific client (e.g., client A). The hypervisor 300 is also responsible for configuring 354 the page tables 310 used by the SMMU (e.g., micro-TLB A 102a) that map to the memory aperture (e.g., aperture L) assigned by the hypervisor for that specific client program image. Thus, the device's hypervisor 300 is responsible for pre-vetting the program image that is loaded into a specific memory aperture and assigning a C-ID to the client and the micro-TLB tied to the program image loaded.

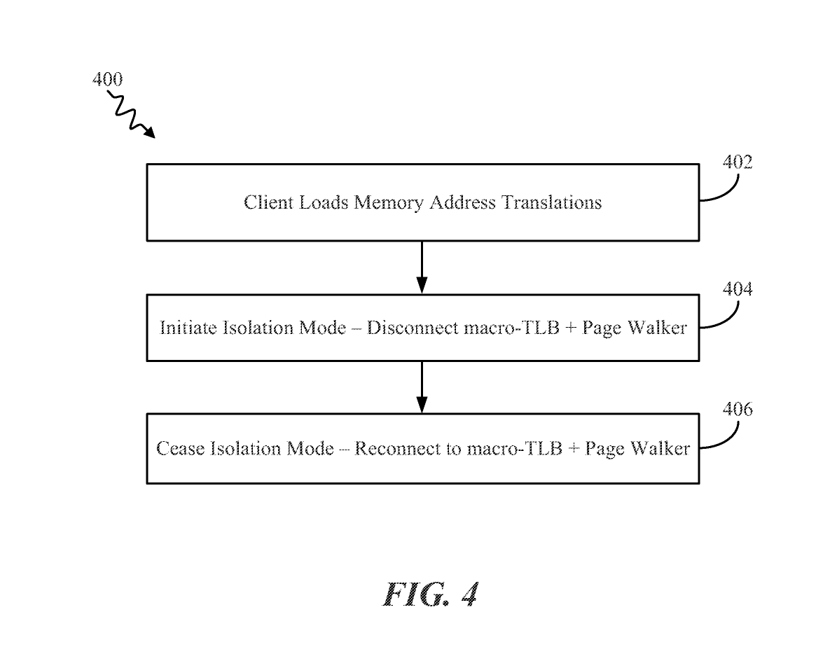

FIG. 4 illustrates a high-level process flow diagram of the device enforcing memory access control policies while a portion of the SMMU (e.g., macro-TLB and page walker circuit) enters a lower power state or is otherwise not in communication with a micro-TLB tasked with enforcing access control policies for a memory circuit according to one aspect. First, in preparation of entering isolation mode, a client loads 402 (i.e., pre-loads) an associated micro-TLB with memory address translations. Next, the client initiates 404 isolation mode, thereby severing communications between the micro-TLB that serves the client from the rest of the SMMU including the macro-TLB and page walker circuit. This allows the macro-TLB and page walker circuit to enter a lower power state and save power for the device without having to remain online to assist the micro-TLB with maintenance operations and updates. Finally, the client or some other device component (e.g., SMMU, CPU, etc.) may cease/terminate 406 isolation mode causing communications to be reestablished between the micro-TLB and the rest of the SMMU including the macro-TLB and page walker circuit. For example, the macro-TLB and page walker circuit may “wake up” from the lower power state by turning back ON and communicating with the micro-TLB that serves the client.

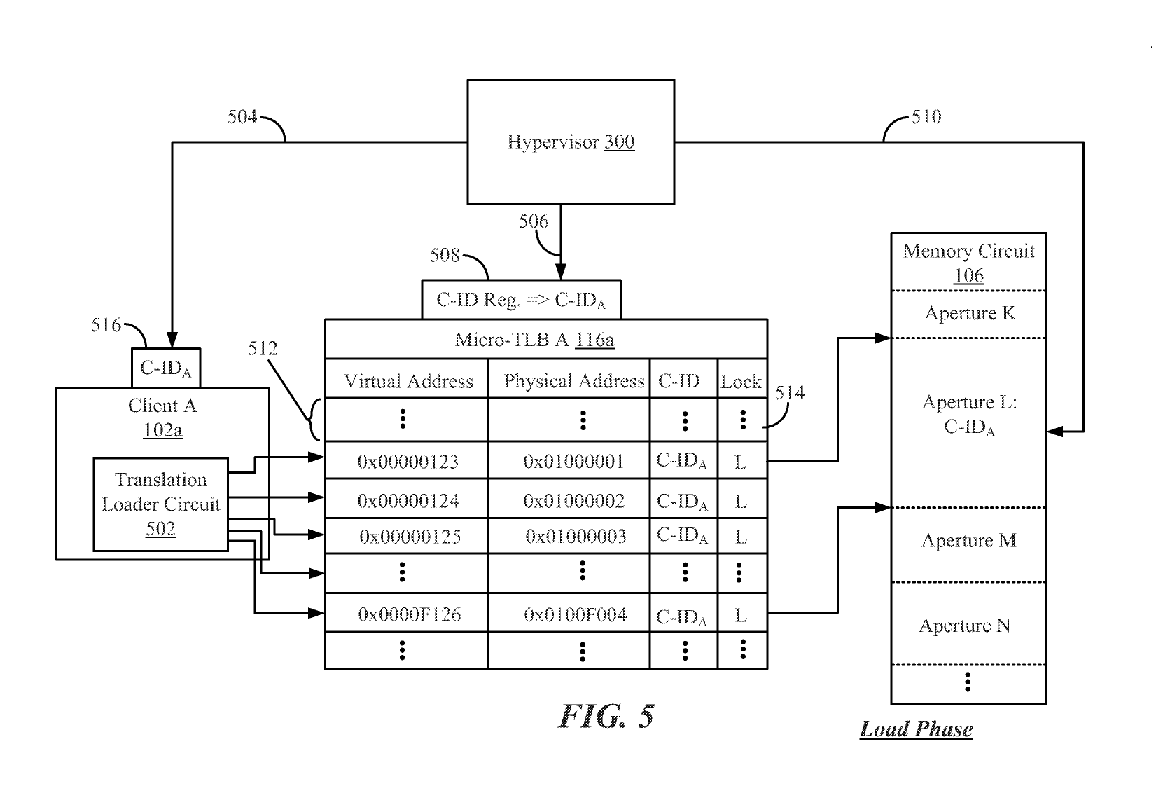

FIG. 5 illustrates a conceptual block diagram of a device client in the load phase 402 (see FIG. 4) (i.e., pre-load phase) according to one aspect. Referring to FIG. 5, a client, such as client A 102a, begins loading (i.e., pre-loading) memory address translations into the micro-TLB (e.g., micro-TLB A 116a) that serves the client. The client 102a may, for example, include a translation loader circuit/module 502 that causes the memory address translations to be loaded into the micro-TLB 116a. The client 102a may do this by touching/accessing some or even all of the physical memory addresses that the hypervisor 300 has authorized as accessible for the client 102a, which in the illustrated example is aperture L of the memory circuit 106. Touching/accessing these physical memory addresses causes the SMMU 104 (FIG. 1) to load these recent memory accesses into the micro-TLB 116a. According to one aspect, the translation loader circuit/module 502 is one example of a means for loading memory address translations for an executable program image associated with a client into a micro-TLB 116a. According to another aspect, a micro-TLB 116a is one example of a means for enforcing memory access control policies for a client.

As described in part above, prior to any loading of a micro-TLB by a client, the hypervisor 300 may generate and assign a C-ID value for a client, which defines the memory aperture the client may access. Thus, prior to loading the micro-TLB 116a with memory address translations by the client 102a, the hypervisor 300 will have assigned 504 C-ID_{A} (client identifier for client A) to the client 102a. The hypervisor 300 will have also written 506 the C-ID_{A} value to a register 508 of the micro-TLB 116a, and associated 510 the memory aperture (e.g., aperture L) with the C-ID (e.g., C-ID_{A}).

As the client 102a begins loading memory address translations in preparation for going into isolation mode, the micro-TLB 116a checks the C-ID value associated with each memory address translation being loaded against the C-ID value stored at its register 508 to make sure the two values match. If the C-ID values match, which in the example shown is C-ID_{A} for client A 102a, then the micro-TLB 116a allows the translation to be loaded and locked into the micro-TLB 116a. As shown in FIGS. 5-8, each memory address translation entry 512 at the micro-TLB 116a may have register 514 indicating the lock/unlock status of that particular entry 512. A locked entry (designated “L”) prevents the entry from being replaced with another translation during the loading phase described below and also when transitioning to the isolation mode/phase. (Unlocked entries are designated “UL”.)

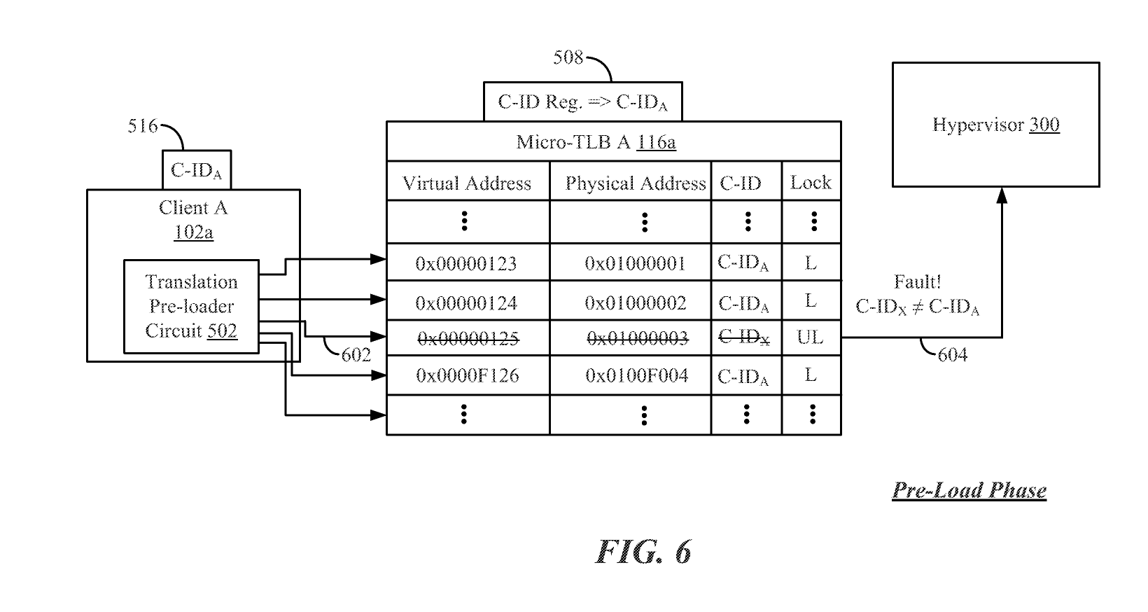

Referring to FIG. 6, if instead the client 102a attempts to load 602 a memory address translation having a different C-ID value (e.g., C-ID_{X}) than the one stored at the register 508 of the micro-TLB 116a associated with the client 102a (i.e., C-ID_{A}), then the micro-TLB 116a reports a fault. Similarly, if the client 102a attempts to load 602 a memory address translation having a physical memory address mapping that is outside the region defined by the corresponding C-ID_{A}, then again the micro-TLB 116a reports a fault. The faults are reported by the micro-TLB 116a to the hypervisor 300. At the conclusion of the loading phase, only loaded and locked memory address translations are saved at the micro-TLB 116a while all other non-locked entries are invalidated (e.g., flushed), as described below.

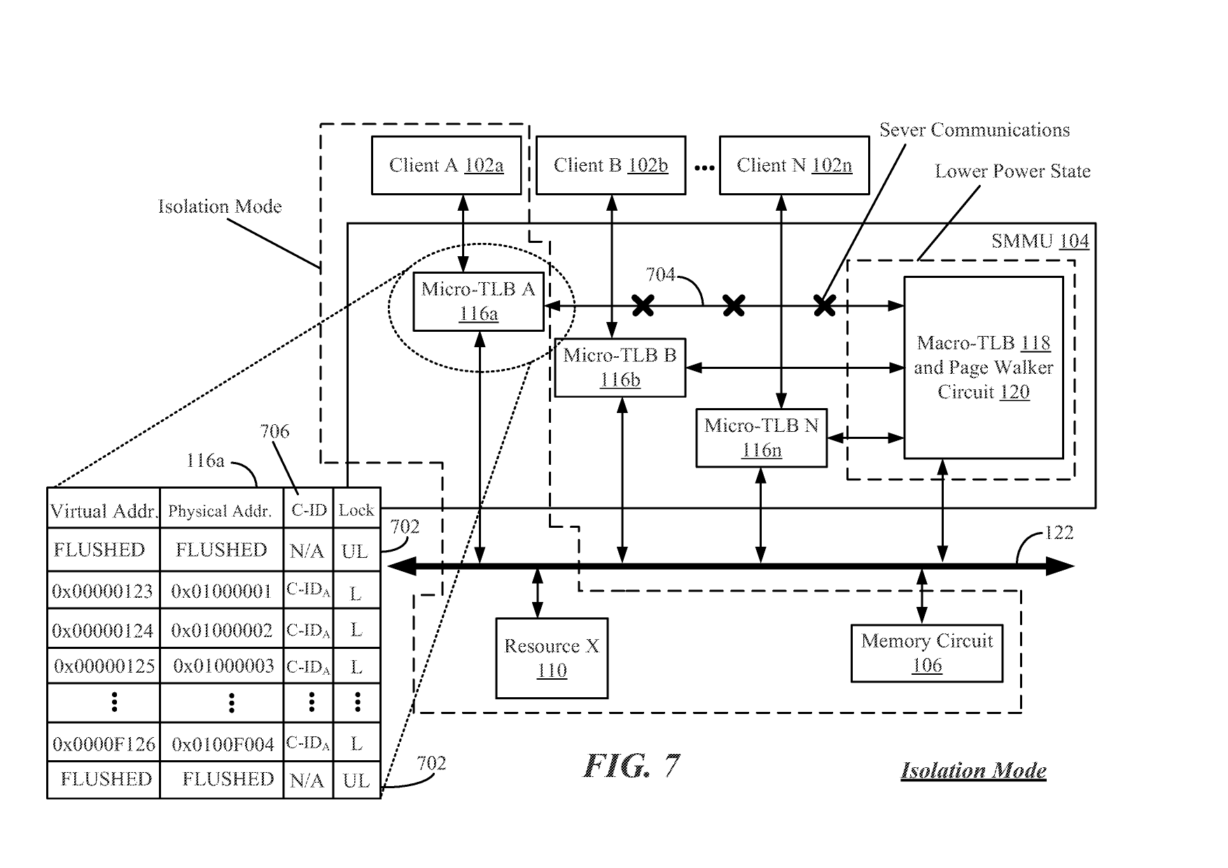

FIG. 7 illustrates a conceptual block diagram of a device client in isolation mode 404 (see FIG. 4) according to one aspect. Referring to FIG. 7, upon the micro-TLB 116a entering isolation mode, all non-locked translation entries 702 (designated by “UL”) at the micro-TLB 116a are invalidated (e.g., flushed). While the micro-TLB 116a is in isolation mode, communications 704 between the micro-TLB 116a and the macro-TLB 118 and page walker 120 are severed and the micro-TLB 116a cannot receive maintenance operations and memory address translation updates from the macro-TLB 118/page walker circuit 120. During this time, the macro-TLB 118 and page walker 120, as well as other components of the device 100 and SMMU 104, may enter a lower power state.

Despite being unable to communicate with the macro-TLB 118 and page walker 120 and receive updates, the micro-TLB 116a enforces memory access control policies for the client 102a and provides needed memory address translations for the client 102a. The micro-TLB 116a is able to do so because all memory address translation entries at the micro-TLB 116a were loaded and locked during the loading phase when each entry was checked to ensure that it had a C-ID value that matched the C-ID value assigned by the hypervisor 300 and stored at the micro-TLB's register 508 (see FIG. 5). Since the C-ID value defines the limited memory region that that particular client can have access to, and all other attempts by the client to load entries that have physical memory addresses that are outside that limited memory region or have C-ID values that do not match the value stored at the associated micro-TLB would have resulted in faults during load, the system can be assured that translation entries loaded and locked into the micro-TLB 116a while operating in isolation mode are legitimate and that access control policies for the client 102a will be enforced. Moreover, the micro-TLB 116a is also able to enforce memory access control policies because the micro-TLB 116a checks the C-ID value 516 of the client (see FIG. 5) requesting memory access against the C-ID values 706 stored at the translation entries to ensure that they too match. That is, while in isolation mode C-ID values 516 of client memory access requests are checked against those C-ID values 706 stored at the micro-TLB 116a to ensure the requesting client is authorized to access those particular memory address translations. For example, while in isolation mode client A 102a having C-ID_{A} may successfully access virtual address 0x00000123 translation entry having C-ID_{A} but client B 102b having C-ID_{B} would fail to gain access to the same address location since C-ID_{B} doesn't match C-ID_{A} 706 stored at the entry.

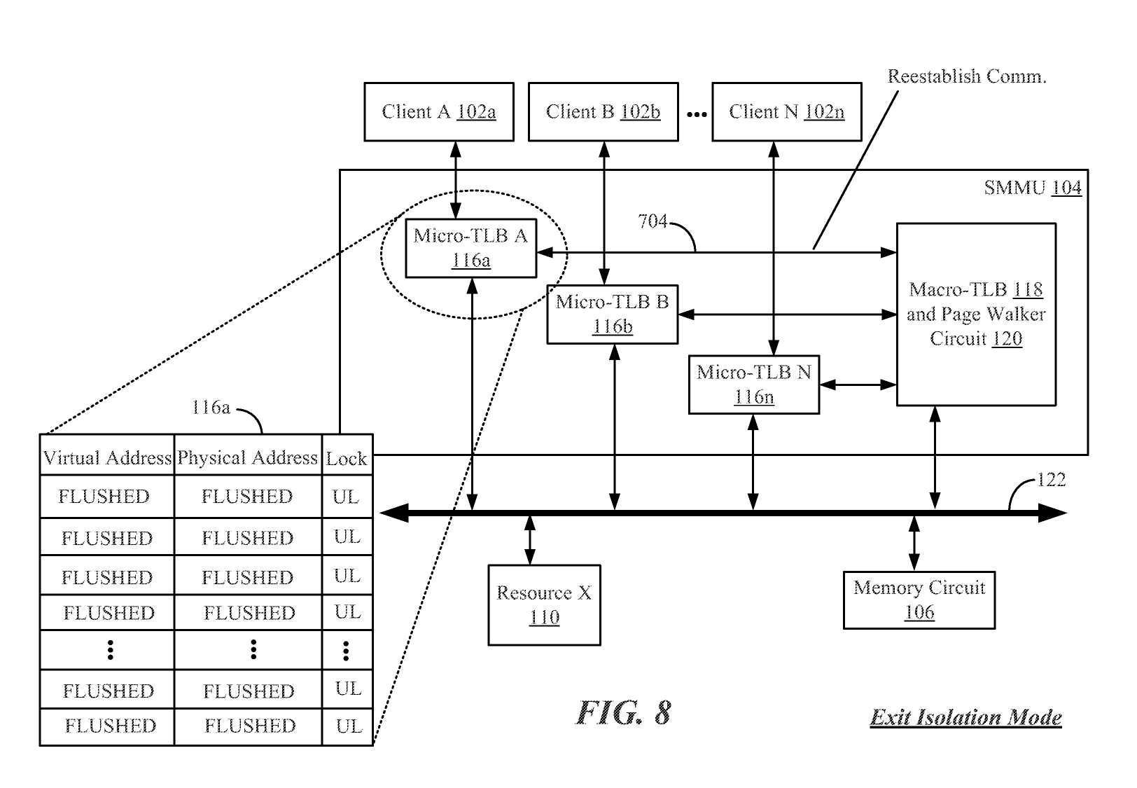

FIG. 8 illustrates a conceptual block diagram of a device client exiting isolation mode 406 (see FIG. 4) according to one aspect. Isolation mode may be ceased by the client 102a, the micro-TLB 116a, or other system components of the device including to the CPU 108 and SMMU 104 (see FIG. 1). The client 102a and micro-TLB 116a may exit isolation mode for various reasons. For example, the client 102a may simply decide for various reasons that it no longer wishes to operate in isolation mode and may therefore request that the macro-TLB 118 and page walker 120 wake up. As another example, an access error of a loaded and locked memory address translation at the micro-TLB 116a caused by a hardware controller reassigning physical memory addresses mapped at the first micro-TLB may also terminate isolation mode.

As shown in FIG. 8, upon exiting isolation mode, all memory address translation entries are invalidated (e.g., flushed) to ensure the micro-TLB 116a is then loaded with updated, fresh mapping information after reconnecting with the macro-TLB 118 and page walker 120.

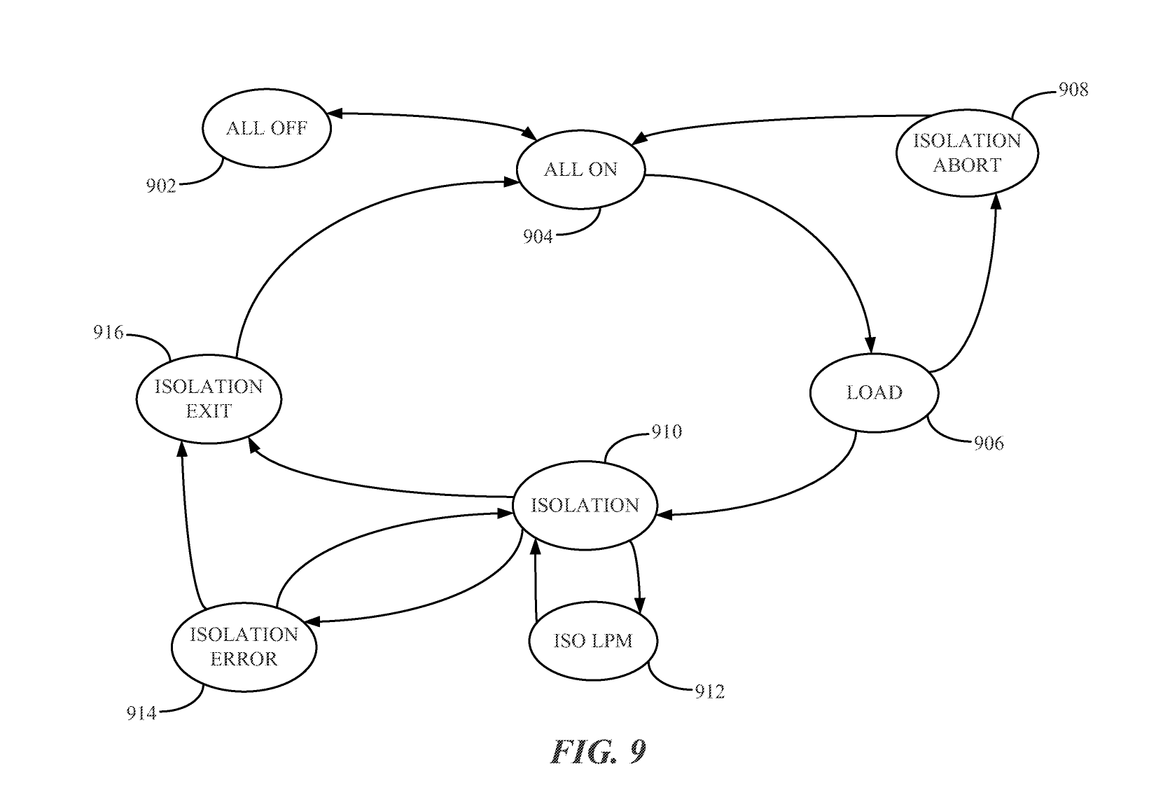

FIG. 9 illustrates a state diagram of the system memory management unit described herein for enforcing access control policies while some components of the SMMU (e.g., macro-TLB and page walker) go offline according to one aspect. At ALL OFF state 902, the client and the SMMU are powered OFF. At ALL ON state 904, the client and the SMMU, including one or more micro-TLBs, macro-TLB, and page walker circuit, are powered on and fully functional. From the ALL ON state 904 the system may enter a LOAD state 906 (i.e., PRE-LOAD state) where the client may decide to start loading/pre-loading a micro-TLB (e.g., micro-TLB associated with the client) with memory address translations as described above in preparation to enter isolation mode. All translations loaded are checked to ensure that the C-ID associated with the translations match the C-ID of the client and the C-ID stored at a register of the micro-TLB. Attempts to load translations that have non-matching C-ID values or physical address locations outside the memory aperture defined by the C-ID at the register are invalidated and result in a fault. The fault may abort 908 the load phase.

While loading is underway, the client may decide for various reasons to abort the load and thus the system transitions to the ISOLATION ABORT state 908. Any entries loaded prior to aborting may be invalidated (e.g., flushed) before returning to the ALL ON state 904.

After loading is complete, all non-locked entries in the micro-TLB may be invalidated (e.g., flushed) and the system may transition to the ISOLATION state 910. In isolation mode the micro-TLB enforces access control policies for the client while communications between the micro-TLB and the rest of the system, including the macro-TLB and page walker circuit, have been severed. During this time the rest of the system, including the macro-TLB and page walker circuit, may enter a lower power state to save power for the underlying device.

Optionally, while in isolation mode, the client may choose to enter a lower power state itself. In such a case, the system transitions from the ISOLATION state 910 to the ISOLATION lower power mode (LPM) state 912. In the ISOLATION LPM state 912, the micro-TLB, the client, and/or resources used by the client may enter a lower power state. The client may then choose to exit its lower power state and return back to the ISOLATION state 910.

While in the ISOLATION state 910 the system may transition to an ISOLATION ERROR state 914 when a fault is reported. For example, this may happen if and when a client attempts to access a memory address that fails to have a corresponding memory address translation entry stored at the micro-TLB. Another example of when the system transitions to the ISOLATION ERROR state 912 is if and when the client attempts to gain access to memory regions that it is unauthorized to access by, for example, providing a C-ID value that fails to match the C-ID value associated with the translation entry stored at the micro-TLB. In either case the micro-TLB may respond by reporting a fault.

Once the system is at the ISOLATION ERROR state 914, the system may either clear the fault and go back to ISOLATION state 910 or exit isolation mode and enter the ISOLATION EXIT state 916. The client itself may also cease/exit isolation mode causing the system to transition from the ISOLATION state 910 to the ISOLATION EXIT state 916. Upon exiting isolation mode, all entries at the micro-TLB are invalidated. The system then transitions from the ISOLATION EXIT state to the ALL ON state 904.

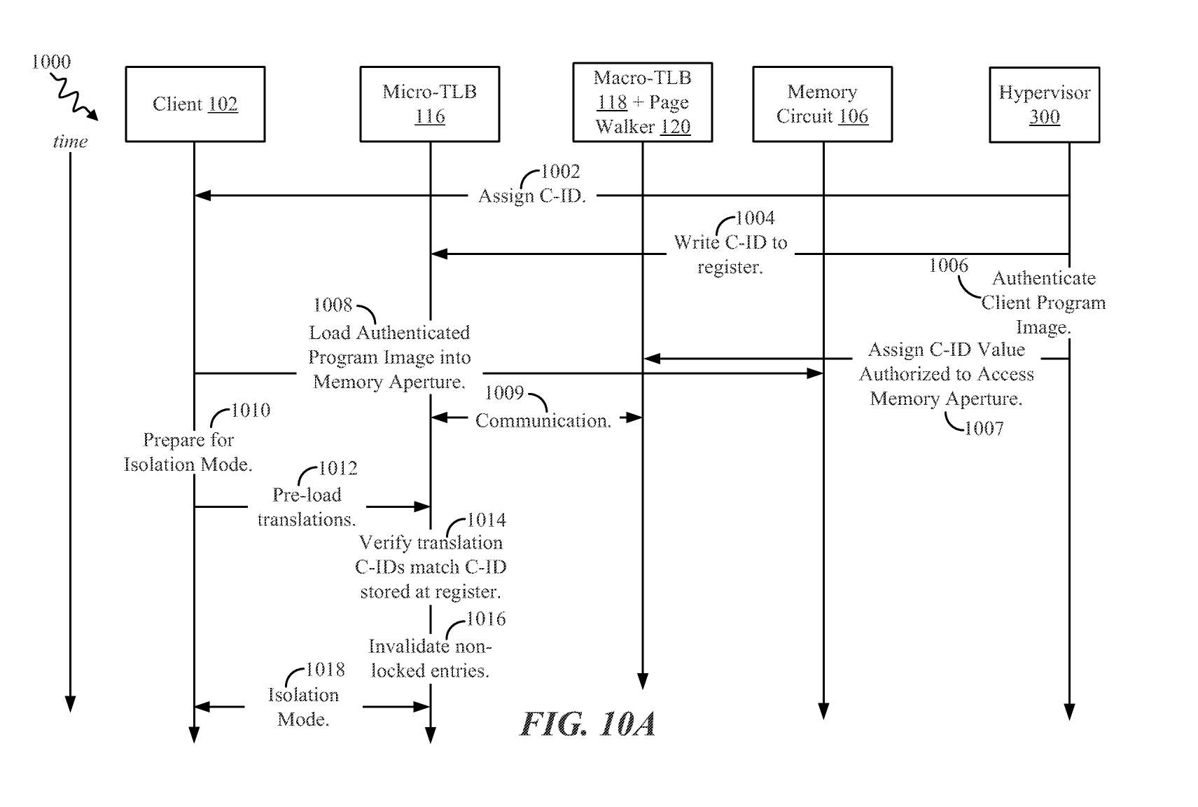

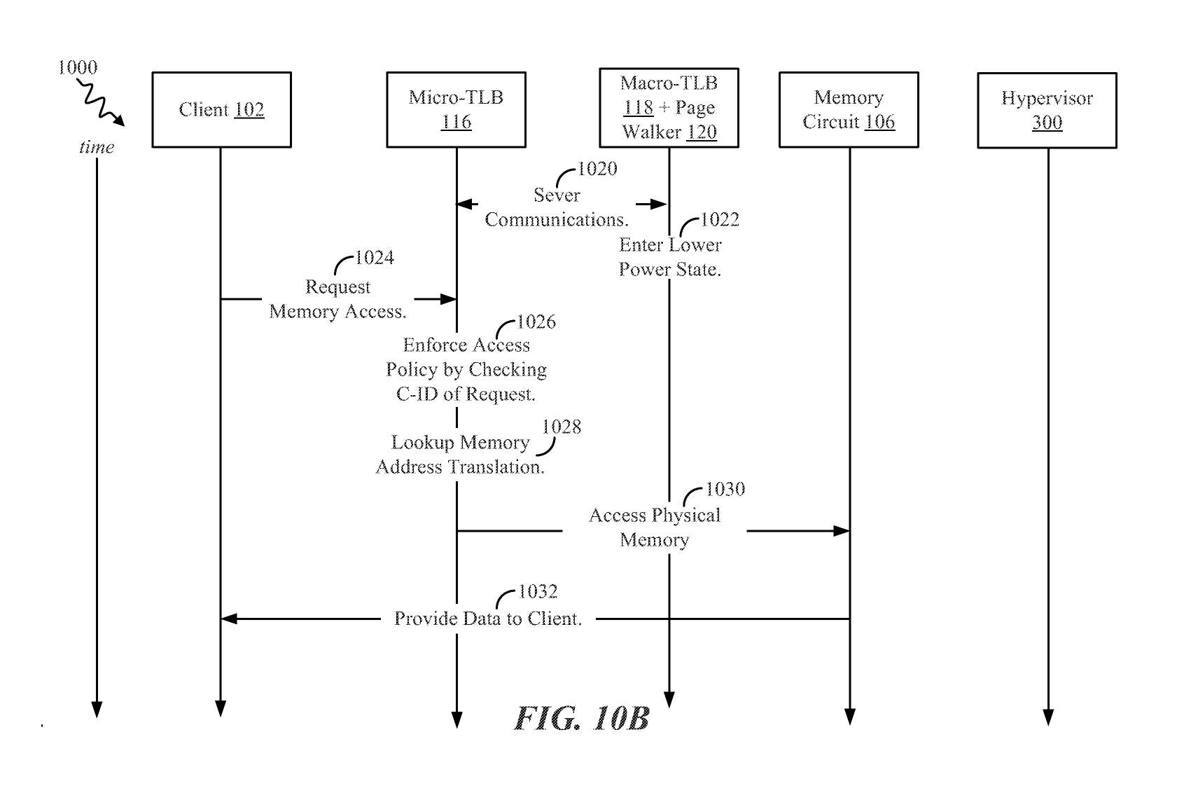

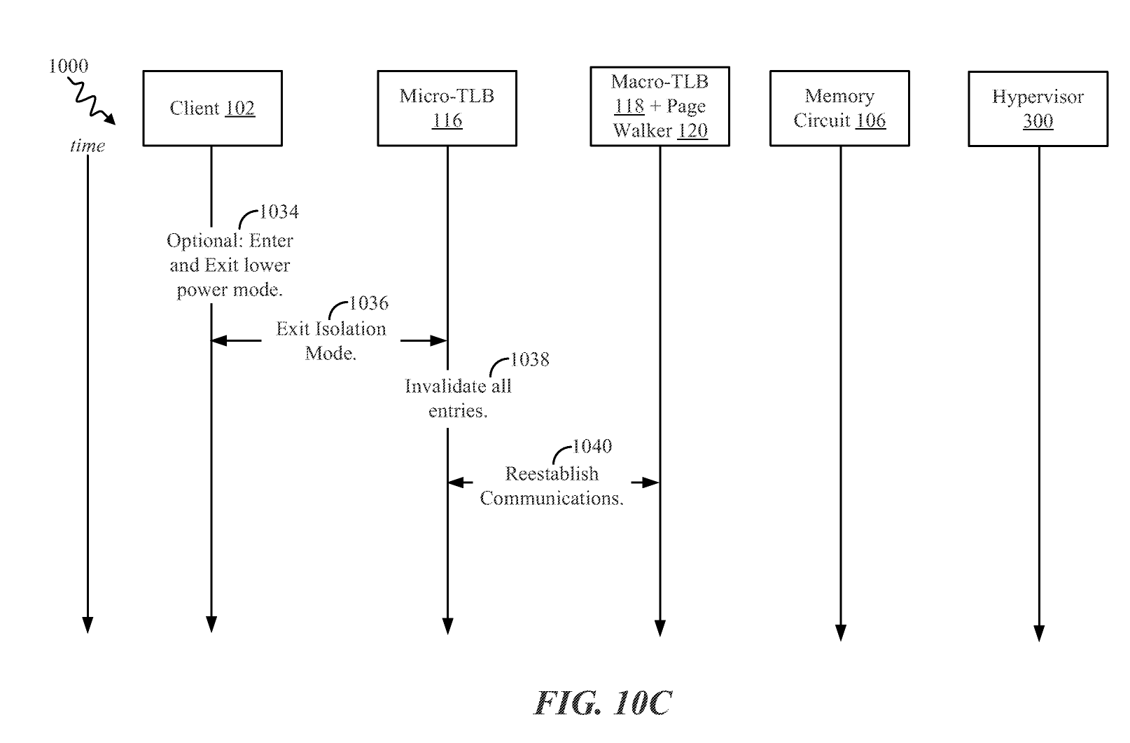

FIGS. 10A, 10B, and 10C illustrate a process flow diagram 1000 for enforcing access control policies of a client while some components of the SMMU (e.g., macro-TLB and page walker) go offline according to one aspect. Referring to FIG. 10A, the hypervisor 300 may assign 1002 a C-ID value to the client 102 identifying the client 102. The hypervisor 300 may also write 1004 the C-ID value to a register of the micro-TLB 116 associated with the client 102. The client program image is authenticated 1006 by the hypervisor 300. The hypervisor 300 also assigns 1007 the C-ID value to the memory aperture storing the client program image and provides this assignment to the macro-TLB 118 and page walker circuit 120. The client may then load 1008 the authenticated client program image into the memory aperture at the memory circuit 106. Prior to any preparations for entering isolation mode, the micro-TLB 116 and the macro-TLB 118/page walker circuit 120 may freely communicate 1009 with one another. For example, the micro-TLB 116 may receive maintenance operations and updates from the macro-TLB 118/page walker circuit 120. Sometime later, however, the client 102 may choose to prepare 1010 for isolation mode by loading 1012 memory address translations into the micro-TLB 116. The micro-TLB 116 verifies 1014 that the C-ID of each translation entry matches the C-ID value stored at its register prior to locking the entry. After all entries have been loaded and locked, the micro-TLB 116 invalidates 1016 all non-locked entries prior to entering 1018 isolation mode.

Referring to FIG. 10B, upon entering isolation mode, communications between the micro-TLB and the macro-TLB 118/page walker circuit 120 are severed 1020 and the micro-TLB 116 is unable to receive maintenance operations and updates from the macro-TLB 118/page walker circuit 120. At this point the macro-TLB 118/page walker 120 may enter 1022 a lower power state but the micro-TLB continues to enforce access control policies between the client 102 and the memory circuit 106. For example, while in isolation mode, the client 102 may request 1024 access to memory regions at the memory circuit 106 and provide its C-ID to the micro-TLB 116. The micro-TLB 116 may in turn enforce 1026 access control policies for the client 102 by making sure the C-ID provided by the client 102 matches the C-ID values of the translation entries at the micro-TLB 116. Assuming the C-ID values match and the micro-TLB 116 determines that the client 102 is authorized to access the memory regions requested, the micro-TLB 116 looks up 1028 the physical memory address associated with the virtual address provided in the client's memory access request. Using the memory address translations stored at the micro-TLB 116, the micro-TLB 116 accesses 1030 the appropriate physical memory addresses at the memory circuit 106. The memory circuit 106 then provides 1032 the corresponding data stored at the physical addresses to the client 102.

Referring to FIG. 10C, while in isolation mode the client 102 may optionally enter and exit 1034 its own lower power mode during times when it desires to go offline and save power. Exiting its own lower power mode still maintains isolation mode between the client 102 and the micro-TLB 116. At some point the client 102 (or system) may decide to exit 1036 isolation mode, upon which the micro-TLB 116 invalidates 1038 all translation entries. After doing so communications between the micro-TLB 116 and the macro-TLB 118/page walker 120 are reestablished 1040.

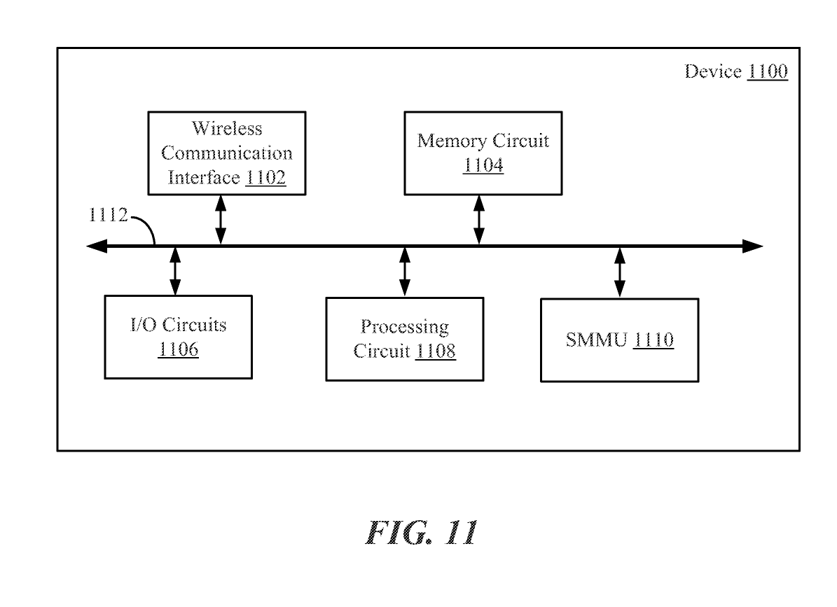

FIG. 11 illustrates a schematic block diagram of a device 1100 according to one aspect of the disclosure. The device 1100 may perform one or more of the steps or actions described with respect to FIGS. 1, 2, 3, 4, 5, 6, 7, 8, 9, 10A, 10B, 10C, 12, and/or 13. The device 1100 may include one or more wireless communication interfaces 1102, one or more memory circuits 1104, one or more input and/or output (I/O) devices/circuits 1106, one or more processing circuits 1108, and/or an SMMU 1110 that may be communicatively coupled to one another. For example, the wireless communication interface 1102, the memory circuit 1104, the I/O devices 1106, the processing circuit 1108, and the SMMU 1110 may be communicatively coupled to each other through a bus 1112.

Among other things, the wireless communication interface 1102 may allow the device 1100 to communicate wirelessly with wireless devices and networks. The memory circuit 1104 may include one or more volatile memory circuits and/or non-volatile memory circuits. Thus, the memory circuit 1104 may include DRAM, SRAM, MRAM, EEPROM, flash memory, etc. The memory circuit 1104 may store one or more executable program images associated with one or more clients. The memory circuit 1104 may also store instructions and data that may be executed by the processing circuit 1108. The I/O devices/circuits 1106 may include one or more keyboards, mice, displays, touchscreen displays, printers, fingerprint scanners, and any other input and/or output devices.

The processing circuit 1108 (e.g., processor, central processing unit (CPU), application processing unit (APU), etc.), which may comprise one or more processing circuits, may execute instructions stored at the memory circuit 1104 and/or instructions stored at another computer-readable storage medium (e.g., hard disk drive, optical disk drive, solid-state drive, etc.) communicatively coupled to the device 1100. The processing circuit 1108 may perform any one of the steps and/or processes described herein including those described with respect to FIGS. 1, 2, 3, 4, 5, 6, 7, 8, 9, 10A, 10B, 12, and/or 13. The processing circuit 1108 may, for example, load memory address translations associated with an executable program image into a micro-TLB. The processing circuit 1108 may also initiate isolation mode for the micro-TLB causing the micro-TLB to sever communications with a macro-TLB and a page walker circuit while in isolation mode. The SMMU 1110 is adapted to enforce memory access control policies for the memory circuit 1104, and includes a plurality of micro-translation lookaside buffers (TLBs), a macro-translation lookaside buffer (TLB), and a page walker circuit.

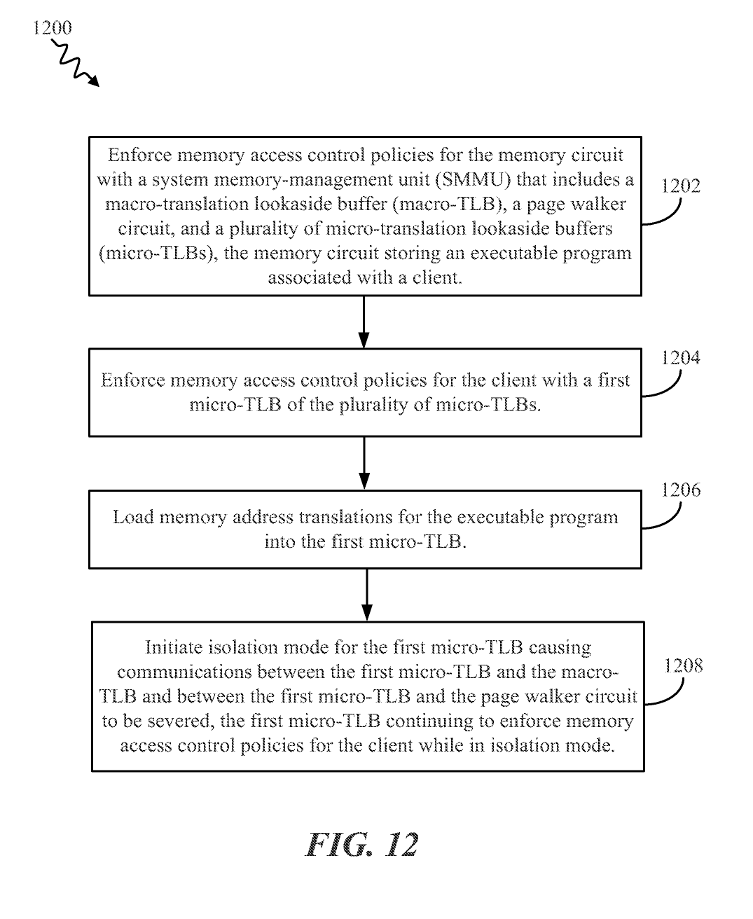

FIG. 12 illustrates a method for enforcing access control policies while some components of the SMMU (e.g., macro-TLB and page walker) go offline according to one aspect. First, memory access control policies for a memory circuit are enforced 1202 with a system memory-management unit (SMMU) that includes a macro-translation lookaside buffer (macro-TLB), a page walker circuit, and a plurality of micro-translation lookaside buffers (micro-TLBs), where the memory circuit stores an executable program associated with a client. Moreover, memory access control policies for the client are enforced 1204 with a first micro-TLB of the plurality of micro-TLBs. When the client desires to enter isolation mode it begins by loading 1206 memory address translations for the executable program into the first micro-TLB. Next, isolation mode is initiated 1208 for the first micro-TLB causing communications between the first micro-TLB and the macro-TLB and between the first micro-TLB and the page walker circuit to be severed. The first micro-TLB, however, continues to enforce memory access control policies for the client while in isolation mode.

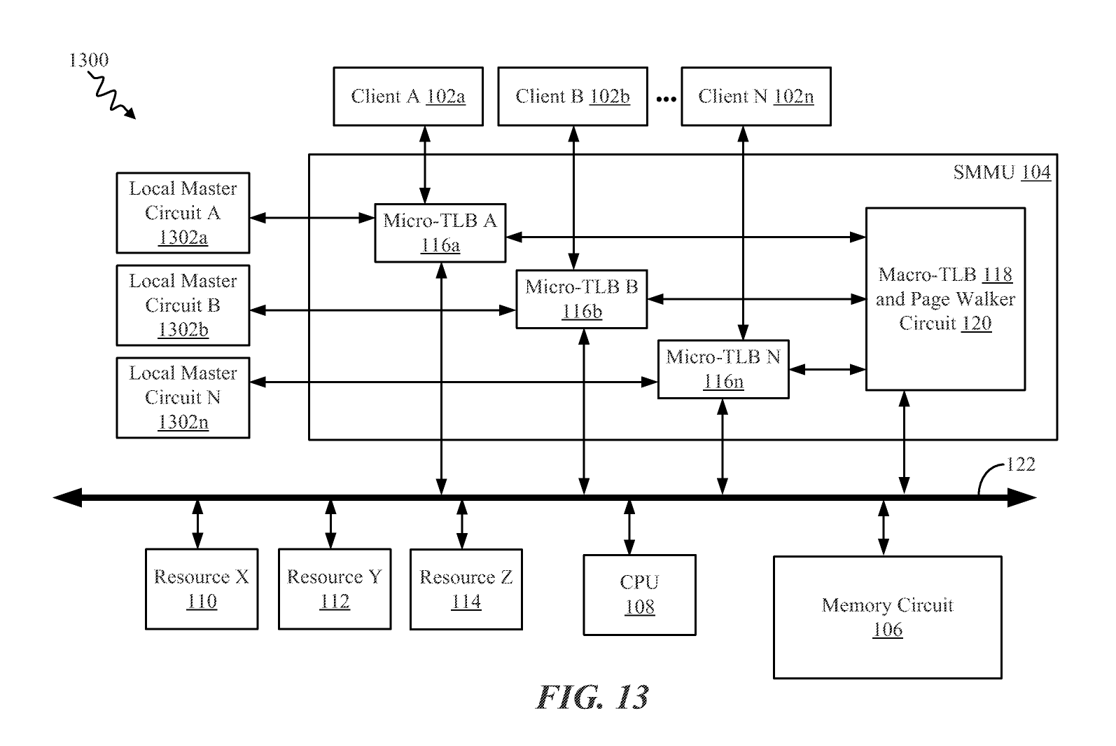

FIG. 13 is a high level block diagram of an electronic device 1300 according to another aspect. The device shown in FIG. 13 is the same as that shown in FIG. 1 except that its micro-TLBs 116a-116n may each be associated with a control circuit that acts as a local master for the micro-TLB. For example, micro-TLB A 116a may be associated with local master circuit A 1302a, micro-TLB B 116b may be associated with local master circuit B 1302b, and micro-TLB N 116n may be associated with local master circuit N 1302n, and so on. Each local master circuit 1302 is able to reprogram its associated micro-TLB 116 while the micro-TLB 116 is in isolation mode. Thus, the aspect shown in FIG. 13 allows for dynamic programmability of the micro-TLBs while in isolation mode. Dynamic programmability may be beneficial in situations where it is desirable to manage local dynamic loading of components in isolation mode (e.g., to increase user experience by providing larger set of features than the physical memory available).

One or more of the components, steps, features, and/or functions illustrated in FIGS. 1, 2, 3, 4, 5, 6, 7, 8, 9, 10A, 10B, 10C, 11, 12, and/or 13 may be rearranged and/or combined into a single component, step, feature or function or embodied in several components, steps, or functions. Additional elements, components, steps, and/or functions may also be added without departing from the invention. The apparatus, devices, and/or components illustrated in FIGS. 1, 2, 3, 5, 6, 7, 8, 11, and/or 13 may be configured to perform one or more of the methods, features, or steps described in FIGS. 3, 4, 5, 6, 7, 8, 9, 10A, 10B, 10C, and/or 12. The algorithms described herein may also be efficiently implemented in software and/or embedded in hardware.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing or containing instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration. As just one example the processing circuit 1108 of FIG. 12 may be an ASIC that is hard wired to specifically perform one or more of the steps illustrated in FIGS. 3, 4, 5, 6, 7, 8, 9, 10A, 10B, 10C, and/or 12.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An apparatus comprising:
a memory circuit storing an executable program associated with a client;
a system memory-management unit (SMMU) adapted to enforce memory access control policies for the memory circuit, the SMMU including a plurality of micro-translation lookaside buffers (micro-TLBs), a macro-translation lookaside buffer (macro-TLB), and a page walker circuit, the plurality of micro-TLBs including a first micro-TLB that enforces memory access control policies for the client; and
a processing circuit communicatively coupled to the memory circuit and the SMMU, the processing circuit adapted to
load memory address translations associated with the executable program into the first micro-TLB, and
initiate isolation mode for the first micro-TLB to cause communications between the first micro-TLB and the macro-TLB and between the first micro-TLB and the page walker circuit to be severed, the first micro-TLB to continue to enforce memory access control policies for the client while in isolation mode.

2. The apparatus of claim 1, wherein the macro-TLB and the page walker circuit enter a lower power state while the first micro-TLB is in isolation mode.

3. The apparatus of claim 1, wherein the memory address translations loaded into the first micro-TLB provide a mapping between virtual memory addresses and physical memory addresses of the memory circuit.

4. The apparatus of claim 1, wherein the first micro-TLB includes a register that stores a client identifier that identifies the client and defines a memory aperture of the first memory circuit that the client is authorized to access.

5. The apparatus of claim 4, wherein the first micro-TLB determines that each memory address translation associated with the executable program being loaded into the first micro-TLB includes an identifier that matches the client identifier stored at the register of the first micro-TLB before allowing the memory address translation to be loaded and locked into the first micro-TLB.

6. The apparatus of claim 4, wherein the executable program is stored at the memory aperture of the first memory circuit.

7. The apparatus of claim 4, further comprising:
a hypervisor adapted to associate the client identifier to the client and write the client identifier to the register.

8. The apparatus of claim 1, wherein the first micro-TLB invalidates non-locked memory address translations stored at the first micro-TLB prior to entering isolation mode.

9. The apparatus of claim 1, wherein the processing circuit is further adapted to:
cease isolation mode for the first micro-TLB causing the first micro-TLB to exit isolation mode and reestablish communications with the macro-TLB and the page walker circuit.

10. The apparatus of claim 9, wherein the first micro-TLB invalidates all memory address translations stored at the first micro-TLB upon exiting isolation mode and reestablishing communications with the macro-TLB and the page walker circuit.

11. The apparatus of claim 9, wherein the processing circuit ceases isolation mode after the first micro-TLB reports a fault caused by the client attempting to access a memory region of the memory circuit that the client is unauthorized to access.

12. The apparatus of claim 1, wherein the processing circuit is further adapted to:
initiate a lower power mode for the micro-TLB, and wherein the macro-TLB and the page walker circuit remain in a lower power state while the micro-TLB is in the lower power mode.

13. The apparatus of claim 1, further comprising:
a hypervisor adapted to authenticate the executable program stored at the first memory circuit during a boot process and configure page tables that map to a memory aperture of the first memory circuit where the executable program is stored.

14. The apparatus of claim 1, wherein the first micro-TLB continuing to enforce memory access control policies for the client while in isolation mode includes:
receiving at the first micro-TLB a memory access request from the client that includes a client identifier identifying the client, the request indicating a memory region of the memory circuit the client desires access to;
determining at the first micro-TLB that the client identifier provided by the client in the memory access request matches a stored client identifier value at the micro-TLB associated with the memory region of the memory circuit the client desires access to; and
providing the client a memory address translation associated with the memory region of the memory circuit the client desires access to.

15. The apparatus of claim 1, further comprising:
a local master circuit adapted to reprogram the first micro-TLB while in isolation mode.

16. A method comprising:
enforcing memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client;
enforcing memory access control policies for the client with a first micro-TLB of the plurality of micro-TLBs;
loading memory address translations for the executable program into the first micro-TLB; and
initiating isolation mode for the first micro-TLB causing communications between the first micro-TLB and the macro-TLB and between the first micro-TLB and the page walker circuit to be severed, the first micro-TLB continuing to enforce memory access control policies for the client while in isolation mode.

17. The method of claim 16, wherein the macro-TLB and the page walker circuit enter a lower power state while the first micro-TLB is in isolation mode.

18. The method of claim 16, wherein the memory address translations loaded into the first micro-TLB provide a mapping between virtual memory addresses and physical memory addresses of the memory circuit.

19. The method of claim 16, wherein the first micro-TLB includes a register that stores a client identifier that identifies the client and defines a memory aperture of the first memory circuit that the client is authorized to access.

20. The method of claim 19, wherein the first micro-TLB determines that each memory address translation associated with the executable program being loaded into the first micro-TLB includes an identifier that matches the client identifier stored at the register of the first micro-TLB before allowing the memory address translation to be loaded and locked into the first micro-TLB.

21. The method of claim 16, wherein prior to entering isolation mode, the first micro-TLB invalidates non-locked memory address translations stored at the first micro-TLB.

22. The method of claim 16, further comprising:
ceasing isolation mode for the first micro-TLB causing the first micro-TLB to exit isolation mode and reestablish communications with the macro-TLB and the page walker circuit.

23. The method of claim 22, wherein the first micro-TLB invalidates all memory address translations stored at the first micro-TLB upon exiting isolation mode and reestablishing communications with the macro-TLB and the page walker circuit.

24. The method of claim 22, wherein isolation mode ceases after the first micro-TLB reports a fault caused by the client attempting to access a memory region of the memory circuit that the client is unauthorized to access.

25. The method of claim 16, wherein the first micro-TLB continuing to enforce memory access control policies for the client while in isolation mode includes:
receiving at the first micro-TLB a memory access request from the client that includes a client identifier identifying the client, the request indicating a memory region of the memory circuit the client desires access to;
determining at the first micro-TLB that the client identifier provided by the client in the memory access request matches a stored client identifier value at the micro-TLB associated with the memory region of the memory circuit the client desires access to; and
providing the client a memory address translation associated with the memory region of the memory circuit the client desires access to.

26. An apparatus comprising:
means for enforcing memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client;
means for enforcing memory access control policies for the client with a first micro-TLB of the plurality of micro-TLBs;
means for loading memory address translations for the executable program into the first micro-TLB; and
means for initiating isolation mode for the first micro-TLB causing communications between the first micro-TLB and the macro-TLB and between the first micro-TLB and the page walker circuit to be severed, the first micro-TLB continuing to enforce memory access control policies for the client while in isolation mode.

27. The apparatus of claim 26, wherein the macro-TLB and the page walker circuit enter a lower power state while the first micro-TLB is in isolation mode.

28. The apparatus of claim 26, further comprising:
means for ceasing isolation mode for the first micro-TLB causing the first micro-TLB to exit isolation mode and reestablish communications with the macro-TLB and the page walker circuit, the first micro-TLB invalidating all memory address translations stored at the first micro-TLB upon exiting isolation mode.

29. A non-transitory computer-readable storage medium having instructions stored thereon, which when executed by at least one processor causes the processor to:
enforce memory access control policies for a memory circuit with a system memory-management unit (SMMU) that includes a macro-translation lookaside buffer (macro-TLB), a page walker circuit, and a plurality of micro-translation lookaside buffers (micro-TLBs), the memory circuit storing an executable program associated with a client at the memory circuit;
enforce memory access control policies for the client with a first micro-TLB of the plurality of micro-TLBs;
load memory address translations for the executable program into the first micro-TLB; and
initiate isolation mode for the first micro-TLB to cause communications between the first micro-TLB and the macro-TLB and between the first micro-TLB and the page walker circuit to be severed, the first micro-TLB to continue to enforce memory access control policies for the client while in isolation mode.

30. The non-transitory computer-readable storage medium of claim 29, wherein the macro-TLB and the page walker circuit enter a lower power state while the first micro-TLB is in isolation mode.
